(19) United States
(12) Patent Application Publication
(10) Pub. No.: US 2026/0333065 A1
(43) Pub. Date: Oct. 22, 2026

(54) METHOD AND APPARATUS FOR RECEIVING AND SENDING PRECODING INFORMATION

(71) Applicant: Beijing Xiaomi Mobile Software Co., Ltd., Beijing (CN)

(72) Inventors: Liangang CHI, Beijing (CN); Li YANG, Beijing (CN)

(21) Appl. No.: 18/994,436

(22) PCT Filed: Jul. 18, 2022
(86) PCT No.: PCT/CN2022/106342

§ 371 Date: Jan. 14, 2025

(51) Int. Cl. H04W 16/28; H04B 7/04; H04B 7/06; H04W 72/20; H04W 72/51

(52) U.S. Cl. CPC H04W 16/28; H04B 7/04013; H04B 7/0639; H04W 72/20; H04W 72/51

(57) ABSTRACT

A method for sending precoding information is executed by a first network side device. The method includes: obtaining a capability value of a second network side device, wherein the capability value is a time required by the second network side device to complete precoding or beam switching in a case of a precoding change or beam information change; and sending the precoding information to the second network side device.

### CROSS-REFERENCE TO RELATED APPLICATIONS

The present application is a U.S. National Stage of International Application No. PCT/CN 2022/106342, filed on Jul. 18, 2022, the content of which is incorporated herein by reference in its entirety.

### FIELD

The present disclosure relates to the field communication technology, in particular to a method and an apparatus for receiving precoding information, and a method and an apparatus for sending precoding information.

### BACKGROUND

A large number of radio frequency relays have been deployed in 2^{nd}-Generation (2G) mobile communication technology, 3^{rd}-Generation (3G) mobile communication technology and 4^{th}-Generation (4G) mobile communication technology for coverage supplement. The relay is a simple and low-cost measure to increase a coverage range of a network. The radio frequency relay has been studied in a 5^{th}-Generation (5G) New Radio (NR) in Release 17 (Rel-17). A smart relay is expected to be introduced by 3^{rd}-Generation Partnership Project (3GPP) subsequently, and certain auxiliary information and control signaling, e.g. for supporting beam measurement and beam control, are introduced for the relay, so as to further improve the relay performance.

### SUMMARY

In a first aspect, the present disclosure provides a method for sending precoding information, executed by a first network side device, including: obtaining a capability value of a second network side device, wherein the capability value is a time required by the second network side device to complete precoding or beam switching in a case of a precoding change or beam information change; and sending the precoding information to the second network side device.

In a second aspect, the present disclosure provides a method for receiving precoding information, executed by a second network side device, including: receiving the precoding information sent by a first network side device.

In a third aspect, the present disclosure provides a method for receiving information, executed by a terminal device, including: receiving a capability value of a second network side device sent by a first network side device, wherein the capability value is a time required by the second network side device to complete precoding switching in a case of a precoding change.

In a fourth aspect, the present disclosure provides a communication apparatus, including a processor and a memory. The memory stores a computer program executable by the processor, and the processor is configured to execute the method in the first aspect.

In a fifth aspect, the present disclosure provides a communication apparatus, including a processor and a memory. The memory stores a computer program executable by the processor, and the processor is configured to execute the method in the second aspect.

In a sixth aspect, the present disclosure provides a communication apparatus, including a processor and a memory. The memory stores a computer program executable by the processor, and the processor is configured to execute the method in the third aspect.

### BRIEF DESCRIPTION OF THE DRAWINGS

The accompanying drawings of the present disclosure will be described briefly.

FIG. 1 is a schematic diagram of a communication system according to an embodiment of the present disclosure;

FIG. 2 is a flowchart of a method for sending precoding information according to an embodiment of the present disclosure;

FIG. 3 is a schematic view showing transmission of the precoding information between devices according to an embodiment of the present disclosure;

FIG. 4 is another flowchart of the method for sending precoding information according to one embodiment of the present disclosure;

FIG. 5 is a flowchart of a method for receiving precoding information according to an embodiment of the present disclosure;

FIG. 6 is another flow chart of the method for receiving precoding information according to an embodiment of the present disclosure;

FIG. 7 is yet another flow chart of the method for receiving precoding information according to an embodiment of the present disclosure;

FIG. 8 is a flowchart of a method for receiving information according to an embodiment of the present disclosure;

FIG. 9 is another flowchart of the method for receiving information according to an embodiment of the present disclosure;

FIG. 10 is a block diagram of a communication apparatus according to an embodiment of the present disclosure;

FIG. 11 is a block diagram of a communication apparatus according to an embodiment of the present disclosure; and FIG. 12 is a block diagram of a chip according to an embodiment of the present disclosure.

### DETAILED DESCRIPTION

The embodiments of the present disclosure will be described hereinafter in details, and examples are shown in the drawings. Identical or similar reference numbers represent an identical or similar element. The following embodiments described with reference to the drawings are for illustrative purposes only, but shall not be used to limit the scope of the present disclosure. In the description of the present disclosure, unless otherwise defined, the symbol “/” refers to “or”, e.g., A/B refers to A or B. The expression “and/or” is merely used to describe a relationship between associated objects, and it may include three relationships. For example, “A and/or B” represents that, there is only A, there are both A and B, and there is only B.

In conventional communication, a wireless environment is an uncontrollable factor, and usually the uncontrollability is adverse to communication efficiency, leading to a decrease in service quality. A propagation distance of a wireless signal is limited by signal attenuation, and signal fading is caused by a multipath effect. Reflection and refraction of a large object are main uncontrollable factors. By deploying a Reconfigurable Intelligence Surface (RIS) on surfaces of various objects in a wireless transmission environment, it is expected to overcome the uncontrollability of a conventional wireless channel, create a smart and programmable wireless channel, and introduce a new paradigm for the future wireless communication.

In the related art, precoding of a smart repeater/RIS and a base station is jointly designed mainly using an alternative optimization technology. Usually, the alternative optimization technology is implemented through different algorithms, so the complexity thereof is too high.

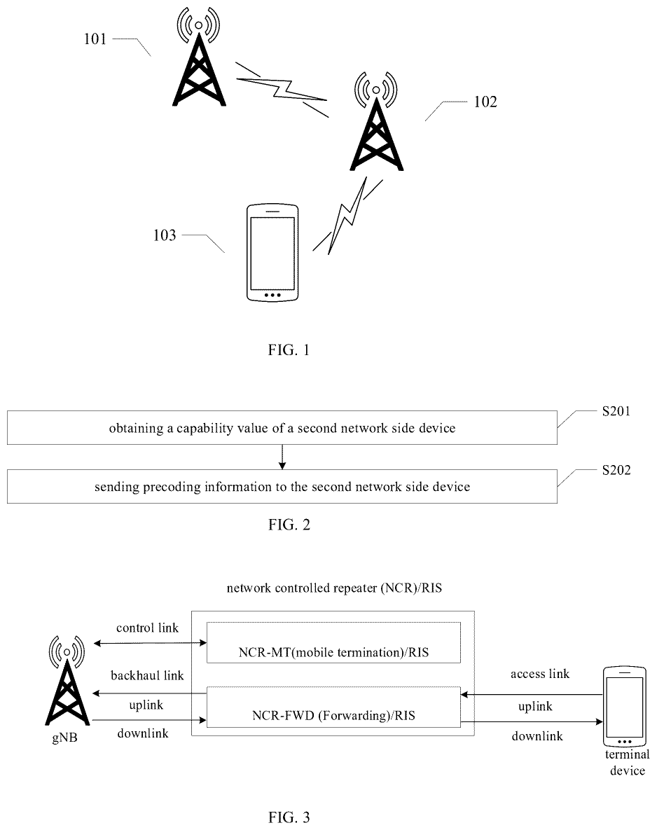

Referring to FIG. 1, which is a schematic diagram of a communication system according to an embodiment of the present disclosure, the communication system includes, but not limited to, one network side device and one terminal device. Quantities and forms of the devices in FIG. 1 are for illustrative purposes only, but shall not be construed as limiting the embodiments of the present disclosure. In actual use, the communication system may include two or more network side devices and two or more terminal devices. In the communication system as shown in FIG. 1, one first network side device 101, one second network side device 102 and one terminal device 103 are taken as an example.

It should be appreciated that, the technical solutions in the embodiments of the present disclosure may be applied to various communication systems, e.g., a Long Term Evolution (LTE) system, a 5^{th}-Generation (5G) mobile communication system, a 5G New Radio (NR) system, or any novel mobile communication system that may occur in the future. It should be further appreciated that, Sidelink in the embodiments of the present disclosure is also called as direct communication link.

In the embodiments of the present disclosure, the first network side device 101 and the second network side device 102 are entities at a network side for sending or receiving a signal. For example, the network side device 101 is an evolved NodeB (eNB), a Transmission Reception Point (TRP), a next generation NodeB (gNB) in the NR system, a base station in the future mobile communication system, or an access point in a Wireless Fidelity (WiFi) system. A specific technology adopted by the network side device and a specific device form thereof will not be particularly defined herein. The network side device in the embodiments of the present disclosure may consist of a Central Unit (CU) and a Distributed Unit (DU), and the CU may also be called as control unit. Through the CU-DU structure, a protocol layer for the network device, e.g., a base station, is divided, i.e., a part of functions of the protocol layer are centrally controlled by the CU, a part of, or all of, the remaining functions of the protocol layer are distributed in the DU, and the DU is controlled by the CU.

In the embodiments of the present disclosure, the terminal device 103 is an entity at a user side for receiving or sending a signal, e.g., a mobile phone. The terminal device may also be called as terminal, User Equipment (UE), Mobile Station (MS), Mobile Terminal (MT), etc. The terminal device may be a vehicle having a communication function, a smart vehicle, a mobile phone, a wearable device, a pad, a computer having a wireless transceiver function, a Virtual Reality (VR) terminal device, an Augmented Reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. In the embodiments of the present disclosure, a specific technology adopted by the terminal device and a specific device form thereof will not be particularly defined.

It should be appreciated that, in the embodiments of the present disclosure, the first network side device may be a communication base station, and the second network side device may be a RIS or a relay device.

It should be appreciated that, the communication system described herein is used to describe the technical solutions provided in the embodiments of the present disclosure in a clearer manner, but shall not be construed as limiting the technical solutions. It is obvious for a person skilled in the art that, along with the evolution of the system architecture as well as the emergence of new service scenarios, the technical solutions are also applicable to similar technical problems.

A method and an apparatus for receiving precoding information and a method and an apparatus for sending precoding information provided in the present disclosure will be described hereinafter in details in conjunction with the drawings.

Referring to FIG. 2 which is a flowchart of a method for sending precoding information according to an embodiment of the present disclosure, the method is executed by a first network side device. As shown in FIG. 2, the method includes, but not limited to, the following steps.

Step S201: a capability value of a second network side device is obtained.

In one embodiment of the present disclosure, the capability value is a time required by the second network side device to complete precoding or beam switching in a case of a precoding change or beam information change.

For example, the first network side device obtains the capability value of the second network side device, and the capability value is used to represent the time required by the second network side device to complete a decoding of control information and complete hardware switching.

In an embodiment of the present disclosure, the obtaining the capability value of the second network side device includes: receiving the capability value of the second network side device sent by the second network side device; or obtaining the capability value to be met by the second network side device based on an agreement in a protocol.

For example, the first network side device receives the capability value of the second network side device sent by the second network side device.

For another example, the first network side device obtains the capability value to be met by the second network side device based on the agreement in the protocol.

In an embodiment of the present disclosure, the capability value includes a first value and/or a second value, the first value is a time required by the second network side device to complete a decoding of control information, and the second value is a hardware switching time of the second network side device.

For example, the capability value includes the first value, and the first value is the time required by the second network side device to complete the decoding of the control information.

For another example, the capability value includes the second value, and the second value is the hardware switching time of the second network side device.

For yet another example, the capability value includes the first value and the second value, the first value is the time required by the second network side device to complete the decoding of the control information, and the second value is the hardware switching time of the second network side device.

It should be appreciated that, in the embodiments of the present disclosure, a time unit of each of a time N1 and a time N2 may be an absolute time (e.g., millisecond), or represented by any of Orthogonal Frequency Division Multiplexing (OFDM) symbol, time slot or subframe number, which will not be particularly defined herein.

It should be appreciated that, in the embodiments of the present disclosure, in a case that the time N2 is smaller than or equal to a predetermined threshold (e.g., 1 millisecond), it may be omitted, i.e., the capability value merely includes the first value. In addition, the time N2 may be 0.

Step S202: the precoding information is sent to the second network side device.

In an embodiment of the present disclosure, the first network side device sends uplink precoding information for the second network side device to the second network side device in a case that a terminal device needs to perform uplink communication.

For example, as shown in FIG. 3 which is a schematic view showing reception and transmission of precoding information between devices according to an embodiment of the present disclosure, uplink refers to a communication of transmitting information sent by the terminal device to a gNB (i.e., the first network side device) via a network controlled relay (i.e., the second network side device), and downlink refers to a communication of transmitting information sent by the gNB to the terminal device via the network controlled relay.

In an embodiment of the present disclosure, the second network side device is a RIS, the uplink precoding information is used to indicate a precoding matrix used in a case that an uplink reflection or transmission is performed by the RIS; or the second network side device is a relay device, and the uplink precoding information is used to indicate a PMI or beam information used in a case that an uplink forwarding is performed by the relay device.

For example, in a case that the second network side device is the RIS, the first network side device sends, to the RIS, the precoding matrix used in a case that the uplink reflection is performed by the RIS.

For another example, in a case that the second network side device is the RIS, the first network side device sends, to the RIS, the precoding matrix used in a case that the uplink transmission is performed by the RIS.

For yet another example, in a case that the second network side device is the relay device, the first network side device sends, to the relay device, the PMI used in a case that the uplink forwarding is performed by the relay device.

For still yet another example, in a case that the second network side device is the relay device, the first network side device sends, to the relay device, the beam information used in a case that the uplink forwarding is performed by the relay device.

In an embodiment of the present disclosure, the first network side device sends downlink precoding information for the second network side device to the second network side device in a case that the terminal device needs to perform downlink communication.

In an embodiment of the present disclosure, the second network side device is a RIS, and the downlink precoding information is used to indicate a precoding matrix used in a case that a downlink reflection or transmission is performed by the RIS; or the second network side device is a relay device, and the downlink precoding information is used to indicate a PMI or beam information used in a case that a downlink forwarding is performed by the relay device.

For example, in a case that the second network side device is the RIS, the first network side device sends, to the RIS, the precoding matrix used in a case that the downlink reflection is performed by the RIS.

For another example, in a case that the second network side device is the RIS, the first network side device sends, to the RIS, the precoding matrix used in a case that the downlink transmission is performed by the RIS.

For yet another example, in a case that the second network side device is the relay device, the first network side device sends, to the relay device, the PMI used in a case that the downlink forwarding is performed by the relay device.

For still yet another example, in a case that the second network side device is the relay device, the first network side device sends, to the relay device, the beam information used in a case that the downlink forwarding is performed by the relay device.

By implementing the embodiments of the present disclosure, the first network side device sends the precoding information to the second network side device in a case that communication is performed via the second network side device, so that the second network side device performs relay as well as the switching of the precoding matrix or beam of the RIS based on the precoding information, so as to be adapted to the precoding change or beam information change, thereby to improve the communication reliability.

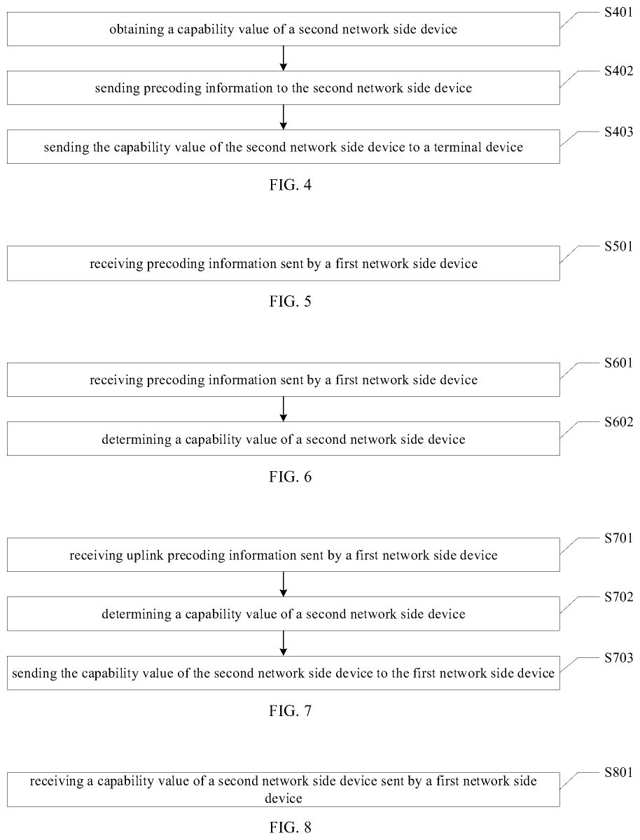

In an embodiment of the present disclosure, the first network side device may further send the obtained capability value of the second network side device to the terminal device. For example, referring to FIG. 4 which is another flowchart of a method for sending precoding information according to an embodiment of the present disclosure, this method is executed by a first network side device. As shown in FIG. 4, the method includes, but not limited to, the following steps.

Step S401: a capability value of a second network side device is obtained.

In an embodiment of the present disclosure, Step S301 may be implemented using any method in the embodiments of the present disclosure, which will not be particularly defined herein.

Step S402: the precoding information is sent to the second network side device.

In an embodiment of the present disclosure, Step S302 may be implemented using any method in the embodiments of the present disclosure, which will not be particularly defined herein.

Step S403: the capability value of the second network side device is sent to a terminal device.

For example, the first network side device sends the capability value of the second network side device obtained in the above step to the terminal device.

In an embodiment of the present disclosure, the first network side device further sends offset data to the terminal device, and the offset data is an offset value between a time when reception of control information is completed by the second network side device and a time when reception of the control information is completed by the terminal device.

For example, the first network side device sends the offset data to the terminal device, and the offset data is an offset value between the time when reception of the control information is completed by the second network side device and the time when reception of the control information is completed by the terminal device.

It should be appreciated that, in the embodiments of the present disclosure, a time unit of the offset value may be an absolute time (e.g., millisecond), or represented by any of OFDM symbol, time slot or subframe number, which will not be particularly defined herein.

By implementing the embodiments of the present disclosure, the first network side device sends the capability value of the second network side device to the terminal device in a case that communication is performed via the second network side device, so as to enable the terminal device to perform adjustment based on the capability value of the second network side device, thereby to improve the communication reliability.

It should be appreciated that, the implementation of the method for sending precoding information has been described in the above embodiments from the perspective of the first network side device. The present disclosure further provides in some embodiments a method for receiving precoding information. The implementation of the method for receiving precoding information will be described hereinafter from the perspective of the second network side device.

It should be appreciated that, in an embodiment of the present disclosure, the second network side device may be a RIS or a relay device.

Referring to FIG. 5 which is a flowchart of a method for receiving precoding information according to an embodiment of the present disclosure, this method is executed by a second network side device. As shown in FIG. 5, the method includes, but not limited to, the following steps.

Step S501: the precoding information sent by a first network side device is received.

In an embodiment of the present disclosure, for uplink communication, the second network side device receives uplink precoding information for the second network side device sent by the first network side device.

In an embodiment of the present disclosure, the second network side device is a RIS, the uplink precoding information is used to indicate a precoding matrix used in a case that an uplink reflection or transmission is performed by the RIS; or the second network side device is a relay device, and the uplink precoding information is used to indicate a PMI or beam information used in a case that an uplink forwarding is performed by the relay device.

For example, in a case that the second network side device is the RIS, the RIS receives the uplink precoding information for the second network side device sent by the first network side device, and the uplink precoding information is used to indicate the precoding matrix used in a case that the uplink reflection is performed by the RIS.

For another example, in a case that the second network side device is the RIS, the RIS receives the uplink precoding information for the second network side device sent by the first network side device, and the uplink precoding information is used to indicate the precoding matrix used in a case that the uplink transmission is performed by the RIS.

For yet another example, in a case that the second network side device is the relay device, the relay device receives the uplink precoding information for the second network side device sent by the first network side device, and the uplink precoding information is used to indicate the PMI or beam information used in a case that the uplink forwarding is performed by the relay device.

For still yet another example, in a case that the second network side device is the relay device, the relay device receives the uplink precoding information for the second network side device sent by the first network side device, and the uplink precoding information is used to indicate the beam information used in a case that the uplink forwarding is performed by the relay device.

In an embodiment of the present disclosure, for downlink communication, the second network side device receives the downlink precoding information for the second network side device sent by the first network side device.

In an embodiment of the present disclosure, the second network side device is a RIS, the downlink precoding information is used to indicate a precoding matrix used in a case that a downlink reflection or transmission is performed by the RIS; or the second network side device is a relay device, and the downlink precoding information is used to indicate a PMI or beam information used in a case that a downlink forwarding is performed by the relay device.

For example, in a case that the second network side device is the RIS, the RIS receives the downlink precoding information for the second network side device sent by the first network side device, and the downlink precoding information is used to indicate the precoding matrix used in a case that the downlink reflection is performed by the RIS.

For another example, in a case that the second network side device is the RIS, the RIS receives the downlink precoding information for the second network side device sent by the first network side device, and the downlink precoding information is used to indicate the precoding matrix used in a case that the downlink transmission is performed by the RIS.

For yet another example, in a case that the second network side device is the relay device, the relay device receives the downlink precoding information for the second network side device sent by the first network side device, and the downlink precoding information is used to indicate the PMI or beam information used in a case that the downlink forwarding is performed by the relay device.

For still yet another example, in a case that the second network side device is the relay device, the relay device receives the downlink precoding information for the second network side device sent by the first network side device, and the downlink precoding information is used to indicate the beam information used in a case that the downlink forwarding is performed by the relay device.

By implementing the embodiments of the present disclosure, the second network side device receives the precoding information sent by the first network side device, and performs the precoding matrix or beam switching based on the precoding information in a case that communication is performed via the second network side device, so as to be adapted to the precoding change or beam information change, thereby to improve the communication reliability.

In an embodiment of the present disclosure, the second network side device determines its capability value in response to receiving indication information sent by the first network side device. For example, referring to FIG. 6 which is another flowchart of a method for receiving precoding information according to an embodiment of the present disclosure, this method is executed by a second network side device. As shown in FIG. 6, the method includes, but not limited to, the following steps.

Step S601: the precoding information sent by a first network side device is received.

In an embodiment of the present disclosure, Step S601 may be implemented using any method in the embodiments of the present disclosure, which will not be particularly defined herein.

Step S602: a capability value of the second network side device is determined.

In an embodiment of the present disclosure, the capability value is a time required by the second network side device to complete precoding switching in a case of a precoding change. In an embodiment of the present disclosure, the capability value includes a first value, and the first value is a time N1 required by the second network side device to complete a decoding of control information.

For example, the capability value includes the first value, and the first value represents the time N1 required by the second network side device to complete the decoding of the control information.

By implementing the embodiments of the present disclosure, the second network side device receives indication information sent by the first network side device, determines the capability value of the second network side device, and sends the capability value to a terminal device in a case that communication is performed via the second network side device, so as to enable the terminal device to perform adjustment based on the capability value, thereby to improve the communication reliability.

In an embodiment of the present disclosure, after determining the capability value, the second network side device may further send the capability value to the terminal device. For example, referring to FIG. 7 which is yet another flowchart of a method for receiving precoding information according to an embodiment of the present disclosure, this method is executed by a second network side device. As shown in FIG. 7, the method includes, but not limited to, the following steps.

Step S701: the precoding information sent by a first network side device is received.

In an embodiment of the present disclosure, Step S701 may be implemented using any method in the embodiments of the present disclosure, which will not be particularly defined herein.

Step S702: a capability value of the second network side device is determined.

In an embodiment of the present disclosure, Step S702 may be implemented using any method in the embodiments of the present disclosure, which will not be particularly defined herein.

Step S703: the capability value of the second network side device is sent to the first network side device.

In an embodiment of the present disclosure, the capability value includes a first value, and the first value is a time N1 required by the second network side device to complete a decoding of control information.

For example, the capability value includes the first value, and the first value is the time N1 required by the second network side device to complete the decoding of the control information.

In an embodiment of the present disclosure, the method further includes: determining a time n when reception of the control information is completed by the second network side device, wherein the control information at least includes new precoding information for the second network side device; and within a first time period, performing signal processing using a previously-obtained precoding matrix or beam, wherein the first time period is a time period from the time n to a first time, and the first time is a sum of the time n and the time N1.

For example, the second network side device determines a time point corresponding to the time n when reception of new precoding information for the second network side device is completed by the second network side device, and within the first time period from the time point corresponding to the time n as a start time to a time point corresponding to a sum of the time point corresponding to the time n and the time N1 as an end time, performs the signal processing using the previously-obtained precoding matrix.

Alternatively or additionally, in an embodiment of the present disclosure, the method further includes: after the first time and before receiving new control information, enabling a precoding matrix or beam indicated by the control information completely received at the time n.

For example, the second network side device determines a time point corresponding to the time n when reception of new precoding information for the second network side device is completed by the second network side device, and after a time point corresponding to a sum of the time point corresponding to the time n and the time N1 and before receiving the new control information, enables the precoding matrix or beam indicated by the control information completely received at the time n.

In some embodiments of the present disclosure, the above capability value includes a first value and a second value, the first value is a time N1 required by the second network side device to complete a decoding of control information, and the second value is a hardware switching time N2 of the second network side device.

For example, the above capability value includes the first value representing the time N1 required by the second network side device to complete the decoding of the control information, and the second value representing the hardware switching time N2 of the second network side device.

Alternatively or additionally, the method further includes: determining a time n when reception of the control information is completed by the second network side device, wherein the control information at least includes new precoding information for the second network side device; and within a first time period, performing signal processing using a previously-obtained precoding matrix or beam, wherein the first time period is a time period from the time n to a first time, and the first time is a sum of the time n and the time N1.

For example, the second network side device determines a time point corresponding to the time n when reception of new precoding information for the second network side device is completed by the second network side device, and within the first time period from the time point corresponding to the time n as a start time to a time point corresponding to a sum of the time point corresponding to the time n and the time N1 as an end time, performs the signal processing using the previously-obtained precoding matrix.

Alternatively or additionally, the method further includes: within a second time period, not constraining the precoding matrix or beam used by the second network side device. The second time period is a time period from the first time to a second time, and the second time is a sum of the first time and the hardware switching time N2.

For example, the second network side device determines a time point corresponding to the time n, and within the time period from the time point corresponding to a sum of the time point corresponding to the time n and the time N1 as a start time to a time point corresponding to a sum of the time point corresponding to the time n and the hardware switching time N2 as an end time, does not constrain the precoding matrix used by the second network side device.

For another example, the second network side device determines a time point corresponding to the time n, and within the time period from the time point corresponding to a sum of the time point corresponding to the time n and the time N1 as a start time to a time point corresponding to a sum of the time point corresponding to the time n and the hardware switching time N2 as an end time, does not constrain the beam used by the second network side device.

Alternatively or additionally, after the second time and before receiving new control information, the second network side device enables a precoding matrix or beam indicated by the control information completely received at the time n.

For example, the second network side device determines a time point corresponding to the time n, and after the time corresponding to a sum of the time point corresponding to the time n, the time N1 and the time N2, enables the precoding matrix indicated by the control information completely received at the time n.

For another example, the second network side device determines a time point corresponding to the time n, and after the time corresponding to a sum of the time point corresponding to the time n, the time N1 and the time N2, enables the beam indicated by the control information completely received at the time n.

By implementing the embodiments of the present disclosure, the second network side device determines the time n when the reception of the control information is completed by the second network side device, and performs corresponding processing on the used precoding matrix or beam within different time periods based on the time n, the time N1 and the time N2 to perform relay as well as precoding matrix or beam switching of the RIS, so as to be adapted to a precoding change or beam information change, thereby to improve the communication reliability.

In an embodiment of the present disclosure, the performing the signal processing using the previously-obtained precoding matrix or beam includes: in a case that there is an uplink and downlink channel reciprocity between the first network side device and a terminal device, performing the signal processing using a precoding matrix or beam obtained at a previous moment; or in a case that there is an uplink data transmission for the terminal device and there is no uplink and downlink channel reciprocity between the first network side device and the terminal device, performing the signal processing using a precoding matrix or beam used by a previous uplink channel; or in a case that there is a downlink data transmission for the first network side device and there is no uplink and downlink channel reciprocity, performing the signal processing using a precoding matrix or beam used by a previous downlink channel.

For example, in a case that there is the uplink and downlink channel reciprocity, the second network side device performs the signaling processing using the precoding matrix obtained at a previous moment.

For another example, in a case that there is the uplink and downlink channel reciprocity, the second network side device performs the signaling processing using the beam obtained at the previous moment.

For yet another example, in a case that there is the uplink data transmission and there is no uplink data transmission and there is no uplink and downlink channel reciprocity, the second network side device performs the signaling processing using the precoding matrix used by a previous uplink channel.

For still yet another example, in a case that there is the uplink data transmission and there is no uplink and downlink channel reciprocity, the second network side device performs the signaling processing using the beam used by the previous uplink channel.

For still yet another example, in a case that there is the uplink data transmission and there is no uplink and downlink channel reciprocity, the second network side device performs the signaling processing using the precoding matrix used by a previous downlink channel.

For still yet another example, in a case that there is the uplink data transmission and there is no uplink and downlink channel reciprocity, the second network side device performs the signaling processing using the beam used by the previous downlink channel.

By implementing the embodiments of the present disclosure, the second network side device uses different precoding matrices or beams to perform the signal processing based on different uplink/downlink transmission situations, so as to be adapted to the precoding change or beam information change, thereby to improve the communication reliability.

It should be appreciated that, the implementation of the method for receiving precoding information has been described in the above embodiments from the perspective of the first network side device and the second network side device. The present disclosure further provides in some embodiments a method for receiving information. The implementation of the method for receiving information will be described hereinafter from the perspective of the terminal device.

Referring to FIG. 8 which is a flowchart of a method for receiving information according to an embodiment of the present disclosure, this method is executed by a terminal device. As shown in FIG. 8, the method includes, but not limited to, the following steps.

Step S801: a capability value of a second network side device sent by a first network side device is received.

The capability value is a time required by the second network side device to complete precoding switching in a case of a precoding change.

For example, the terminal device receives the capability value of the second network side device sent by the first network side device, and the capability value is the time required by the second network side device to complete precoding switching in a case of the precoding change.

By implementing the embodiments of the present disclosure, the terminal device receives the capability value of the second network side device sent by the first network side device, and performs corresponding adjustment based on the capability value in a case that communication is performed via the second network side device, so as to improve the communication reliability.

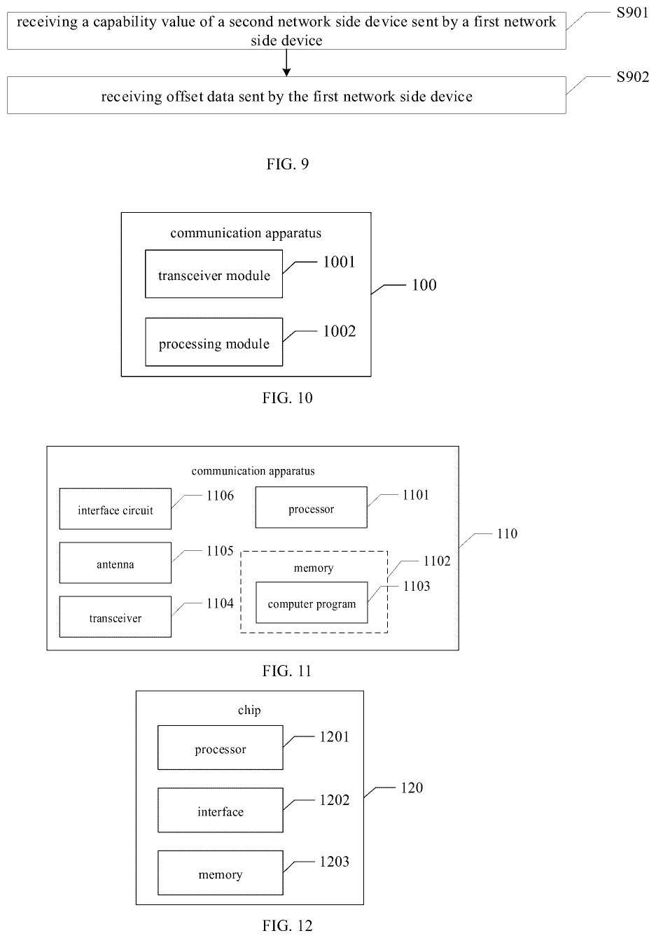

Referring to FIG. 9 which is another flowchart of a method for receiving information according to an embodiment of the present disclosure, and this method is executed by a terminal device. As shown in FIG. 9, the method includes, but not limited to, the following steps.

Step S901: a capability value of a second network side device sent by a first network side device is received.

In an embodiment of the present disclosure, Step S901 may be implemented using any method in the embodiments of the present disclosure, which will not be particularly defined herein.

Step S902: offset data sent by the first network side device is received.

The offset data is an offset value between a time when reception of control information is completed by the second network side device and a time when reception of the control information is completed by the terminal device.

For example, the terminal device receives the offset data sent by the first network side device, and the offset data is an offset value between the time when the reception of the control information is completed by the second network side device and the time when the reception of the same control information is completed by the terminal device.

In an embodiment of the present disclosure, the capability value includes a first value, and the first value is a first time required by the second network side device to complete a decoding of the control information.

Alternatively or additionally, in an embodiment of the present disclosure, the method further includes: determining a time m when reception of the control information is completed by the terminal device, wherein the control information at least includes new precoding information for the second network side device; and within a third time period, generating a reception or transmission beam using previously-obtained precoding matrix indication information or beam indication information, wherein the third time period is a time period from a third time to a fourth time, the third time is a sum of the time m and the offset value, and the fourth time is a sum of the third time and a time N1.

For example, the terminal device determines a time point corresponding to the time m, and within a time period from a time corresponding to a sum of the time point corresponding to the time m and the offset value as a start time to a time corresponding to a sum of the time point corresponding to the time m, the offset value and the time N1 as an end time, generates the reception or transmission beam using the previously-obtained precoding matrix indication information.

For another example, the terminal device determines a time point corresponding to the time m, and within a time period from a time corresponding to a sum of the time point corresponding to the time m and the offset value as a start time to a time corresponding to a sum of the time point corresponding to the time m, the offset value and the time N1 as an end time, generates the reception or transmission beam using the previously-obtained beam indication information.

Alternatively or additionally, in an embodiment of the present disclosure, the method further includes: after the fourth time and before receiving new control information, enabling a precoding matrix or beam indicated by the control information completely received at the time m to generate the reception or transmission beam.

For example, the terminal device determines a time point corresponding to the time m, and after a time corresponding to a sum of the time point corresponding to the time m, the offset value and the time N1 and before receiving the new control information, enables the precoding matrix or beam indicated by the control information completely received at the time m to generate the reception beam.

For another example, the terminal device determines a time point corresponding to the time m, and after a time corresponding to a sum of the time point corresponding to the time m, the offset value and the time N1 and before receiving the new control information, enables the precoding matrix or beam indicated by the control information completely received at the time m to generate the transmission beam.

In an embodiment of the present disclosure, the capability value includes a first value and a second value, the first value is a time N1 required by the second network side device to complete a decoding of the control information, and the second value is a hardware switching time N2 of the second network side device.

Alternatively or additionally, in an embodiment of the present disclosure, the method further includes: determining a time m when the reception of the control information is completed by the terminal device, wherein the control information at least includes new precoding information for the second network side device; and within a third time period, generating a reception or transmission beam using previously-obtained precoding matrix indication information or beam indication information, wherein the third time period is a time period from a third time to a fourth time, the third time is a sum of the time m and the offset value, and the fourth time is a sum of the third time and the time N1. For example, the terminal device determines a time point corresponding to the time m, and within a time period from a time corresponding to a sum of the time point corresponding to the time m and the offset value as a start time to a time corresponding to a sum of the time point corresponding to the time m, the offset value and the time N1 as an end time, generates the reception beam using the previously-obtained precoding matrix indication information.

For another example, the terminal device determines a time point corresponding to the time m, and within a time period from a time corresponding to a sum of the time point corresponding to the time m and the offset value as a start time to a time corresponding to a sum of the time point corresponding to the time m, the offset value and the time N1 as an end time, generates the transmission beam using the previously-obtained precoding matrix indication information.

For yet another example, the terminal device determines a time point corresponding to the time m, and within a time period from a time corresponding to a sum of the time point corresponding to the time m and the offset value as a start time to a time corresponding to a sum of the time point corresponding to the time m, the offset value and the time N1 as an end time, generates the reception beam using the previously-obtained beam indication information.

For still yet another example, the terminal device determines a time point corresponding to the time m, and within a time period from a time corresponding to a sum of the time point corresponding to the time m and the offset value as a start time to a time corresponding to a sum of the time point corresponding to the time m, the offset value and the time N1 as an end time, generates the transmission beam using the previously-obtained beam indication information.

Alternatively or additionally, in an embodiment of the present disclosure, the method further includes: within a fourth time period, not constraining a precoding matrix or beam used by the terminal device. The fourth time period is a time period from the fourth time to a fifth time, and the fifth time is a sum of the fourth time and the hardware switching time N2.

For example, the terminal device determines a time point corresponding to the time m, and within a time period from a time corresponding to a sum of the time point corresponding to the time m, the offset value and the time N1 as a start time to a time corresponding to a sum of the time point corresponding to the time m, the offset value, the time N1 and the time N2 as an end time, does not constrain the precoding matrix used by the terminal device.

For another example, the terminal device determines a time point corresponding to the time m, and within a time period from a time corresponding to a sum of the time point corresponding to the time m, the offset value and the time N1 as a start time to a time corresponding to a sum of the time point corresponding to the time m, the offset value, the time N1 and the time N2 as an end time, does not constrain the beam used by the terminal device.

Alternatively or additionally, in an embodiment of the present disclosure, the method further includes: after the fifth time and before receiving new control information, enabling a precoding matrix or beam indicated by the control information completely received at the time m to generate the reception or transmission beam.

For example, the terminal device determines a time point corresponding to the time m, and after a time corresponding to a sum of the time point corresponding to the time m, the offset value, the time N1 and the time N2 and before receiving the new control information, enables the precoding matrix indicated by the control information completely received at the time m to generate the reception or transmission beam.

For another example, the terminal device determines a time point corresponding to the time m, and after a time corresponding to a sum of the time point corresponding to the time m, the offset value, the time N1 and the time N2 and before receiving the new control information, enables the beam indicated by the control information completely received at the time m to generate the reception or transmission beam.

By implementing the embodiments of the present disclosure, the terminal device receives the capability value of the second network side device sent by the first network side device and the offset data, determines the time m when the reception of the control information is received by the second network side device, and adjusts the used precoding matrix or beam within different time periods, so as to be adapted to the precoding change or beam information change, thereby to improve the communication reliability.

Alternatively or additionally, in an embodiment of the present disclosure, the generating the reception or transmission beam using the previously-obtained precoding matrix indication information or beam indication information includes: in a case that there is an uplink and downlink channel reciprocity between the first network side device and the terminal device, generating the reception or transmission beam using precoding matrix indication information or beam indication information obtained at a previous moment; or in a case that there is an uplink data transmission for the terminal device and there is no uplink and downlink channel reciprocity between the first network side device and the terminal device, generating the reception or transmission beam using precoding matrix indication information or beam indication information used by a previous uplink channel; or in a case that there is a downlink data transmission for the first network side device and there is no uplink and downlink channel reciprocity, generating the reception or transmission beam using precoding matrix indication information or beam indication information used by a previous downlink channel.

For example, in a case that there is the uplink and downlink channel reciprocity, the terminal device generates the reception or transmission beam using the precoding matrix indication information obtained at a previous moment.

For another example, in a case that there is the uplink and downlink channel reciprocity, the terminal device generates the reception or transmission beam using the beam indication information obtained at a previous moment.

For yet another example, in a case that there is the uplink data transmission and there is no uplink data transmission and there is no uplink and downlink channel reciprocity, the terminal device generates the reception or transmission beam using the precoding matrix indication information used by a previous uplink channel.

For still yet another example, in a case that there is the uplink data transmission and there is no uplink data transmission and there is no uplink and downlink channel reciprocity, the terminal device generates the reception or transmission beam using the beam indication information used by a previous uplink channel.

For still yet another example, in a case that there is the downlink data transmission and there is no uplink and downlink channel reciprocity, the terminal device generates the reception or transmission beam using the precoding matrix indication information used by a previous downlink channel.

For still yet another example, in a case that there is the downlink data transmission and there is no uplink and downlink channel reciprocity, the terminal device generates the reception or transmission beam using the beam indication information used by a previous downlink channel.

By implementing the embodiments of the present disclosure, the terminal device uses different precoding matrices or beams to perform the signal processing based on different uplink/downlink transmission situations, so as to be adapted to the precoding change or beam information change, thereby to improve the communication reliability.

By implementing the embodiments of the present disclosure, the terminal device receives the capability value of the second network side device and the offset data sent by the first network side device, determines the time m where the reception of the control information is completed by the terminal device, and adjusts the used precoding matrix or beam within different time periods, so as to be adapted to the precoding change or beam information change, thereby to improve the communication reliability.

In the above embodiments of the present disclosure, the methods have been described from the perspectives of the first network side device, the second network side device and the terminal device. In order to achieve various functions in the embodiments of the present disclosure, each of the network side device and the first network side device includes a hardware structure and a software module, i.e., the functions are achieved in the form of the hardware structure, the software module, or a combination thereof. A certain function in these functions is executed through the hardware structure, the software module, or a combination thereof.

FIG. 10 is a block diagram of a communication apparatus 100 according to an embodiment of the present disclosure. The communication apparatus 100 in FIG. 10 includes a transceiver module 1001 and a processing module 1002. The transceiver module 1001 includes a transmission module and/or a reception module, the transmission module is configured to achieve a transmission function, the reception module is configured to achieve a reception function, and the transceiver module 1001 is configured to achieve the transmission function and/or the reception function.

The communication apparatus 100 may be a terminal device, or an apparatus in the terminal device, an apparatus capable of being used in combination with the terminal device. Alternatively, the communication apparatus 100 may be a network side device, an apparatus in the network side device, or an apparatus capable of being used in combination with the network side device.

In a case that the communication apparatus 100 is a network side device (e.g., the first network side device in the above embodiments), the transceiver module 1002 is configured to: obtain a capability value of a second network side device, wherein the capability value is a time required by the second network side device to complete precoding or beam switching in a case of a precoding change or beam information change; and send precoding information to the second network side device.

In an embodiment of the present disclosure, the transceiver module 1002 is specifically configured to: receive the capability value of the second network side device sent by the second network side device; or obtain the capability value to be met by the second network side device based on an agreement in a protocol.

In an embodiment of the present disclosure, the capability value includes a first value and/or a second value, the first value is a time required by the second network side device to complete a decoding of control information, and the second value is a hardware switching time of the second network side device.

In an embodiment of the present disclosure, the transceiver module 1002 is specifically configured to: send uplink precoding information for the second network side device to the second network side device.

In an embodiment of the present disclosure, the second network side device is a RIS, and the uplink precoding information is used to indicate a precoding matrix used in a case that an uplink reflection or transmission is performed by the RIS; or the second network side device is a relay device, and the uplink precoding information is used to indicate a PMI or beam information used in a case that an uplink forwarding is performed by the relay device.

In an embodiment of the present disclosure, the transceiver module 1002 is specifically configured to: send downlink precoding information for the second network side device to the second network side device.

In an embodiment of the present disclosure, the second network side device is a RIS, and the downlink precoding information is used to indicate a precoding matrix used in a case that a downlink reflection or transmission is performed by the RIS; or the second network side device is a relay device, and the downlink precoding information is used to indicate a PMI or beam information used in a case that a forwarding is performed by the relay device.

In an embodiment of the present disclosure, the transceiver module 1002 is further configured to: send the capability value of the second network side device to a terminal device.

In an embodiment of the present disclosure, the transceiver module 1002 is further configured to: send offset data to the terminal device, wherein the offset data is an offset value between a time when reception of the control information is completed by the second network side device and a time when reception of the control information is completed by the terminal device.

With the communication apparatus in the embodiments of the present disclosure, the first network side device sends the precoding information to the second network side device in a case that communication is performed via the second network side device, so that the second network side device performs relay as well as the switching of the precoding matrix or beam of the RIS based on the precoding information, so as to be adapted to the precoding change or beam information change, thereby to improve the communication reliability.

In a case that the communication apparatus 100 is a network side device (e.g., the second network side device in the above embodiments), the transceiver 1002 is configured to receive precoding information sent by a first network side device.

In an embodiment of the present disclosure, the transceiver module 1002 is specifically configured to: receive uplink precoding information for the second network side device sent by the first network side device.

In an embodiment of the present disclosure, the second network side device is a RIS, and the uplink precoding information is used to indicate a precoding matrix used in a case that an uplink reflection or transmission is performed by the RIS; or the second network side device is a relay device, and the uplink precoding information is used to indicate a PMI or beam information used in a case that an uplink forwarding is performed by the relay device.

In an embodiment of the present disclosure, the transceiver module 1002 is specifically configured to: receive downlink precoding information for the second network side device sent by the first network side device.

In an embodiment of the present disclosure, the second network side device is a RIS, and the downlink precoding information is used to indicate a precoding matrix used in a case that a downlink reflection or transmission is performed by the RIS; or the second network side device is a relay device, and the downlink precoding information is used to indicate a PMI or beam information used in a case that a forwarding is performed by the relay device.

In an embodiment of the present disclosure, the communication apparatus further includes a processing module 1002 configured to determine a capability value of the second network side device, and the capability value is a time required by the second network side device to complete precoding switching in a case of a precoding change.

In an embodiment of the present disclosure, the transceiver module 1002 is further configured to: send the capability value of the second network side device to the first network side device.

In an embodiment of the present disclosure, the capability value includes a first value, and the first value is a time N1 required by the second network side device to complete a decoding of control information.

In an embodiment of the present disclosure, the processing module 1002 is further configured to: determine a time n when reception of the control information is completed by the second network side device, wherein the control information at least includes new precoding information for the second network side device; and within a first time period, perform signal processing using a previously-obtained precoding matrix or beam, wherein the first time period is a time period from the time n to a first time, and the first time is a sum of the time n and the time N1.

In an embodiment of the present disclosure, the processing module 1002 is further configured to: after the first time and before receiving new control information, enable a precoding matrix or beam indicated by the control information completely received at the time n.

In an embodiment of the present disclosure, the capability value includes a first value and a second value, the first value is a time N1 required by the second network side device to complete a decoding of control information, and the second value is a hardware switching time N2 of the second network side device.

In an embodiment of the present disclosure, the processing module 1002 is further configured to: determine a time n when reception of the control information is completed by the second network side device, wherein the control information at least includes new precoding information for the second network side device; and within a first time period, perform signal processing using a previously-obtained precoding matrix or beam, wherein the first time period is a time period from the time n to a first time, and the first time is a sum of the time n and the time N1.

In an embodiment of the present disclosure, the processing module 1002 is further configured to: within a second time period, not constrain the precoding matrix or beam used by the second network side device, wherein the second time period is a time period from the first time to a second time, and the second time is a sum of the first time and the hardware switching time N2.

In an embodiment of the present disclosure, the processing module 1002 is further configured to: after the second time and before receiving new control information, enable a precoding matrix or beam indicated by the control information completely received at the time n.

In an embodiment of the present disclosure, the processing module 1002 is specifically configured to: in a case that there is an uplink and downlink channel reciprocity between the first network side device and a terminal device, perform the signal processing using a precoding matrix or beam obtained at a previous moment; or in a case that there is an uplink data transmission for the terminal device and there is no uplink and downlink channel reciprocity between the first network side device and the terminal device, perform the signal processing using a precoding matrix or beam used by a previous uplink channel; or in a case that there is a downlink data transmission for the first network side device and there is no uplink and downlink channel reciprocity, perform the signal processing using a precoding matrix or beam used by a previous downlink channel.

With the communication apparatus in the embodiments of the present disclosure, the second network side device receives the precoding information sent by the first network side device, and performs the precoding matrix or beam switching based on the precoding information in a case that communication is performed via the second network side device, so as to be adapted to the precoding change or beam information change, thereby to improve the communication reliability.

In a case that the communication apparatus 100 is a terminal device, the transceiver module 1002 is configured to receive a capability value of a second network side device sent by a first network side device, and the capability value is a time required by the second network side device to complete precoding switching in a case of a precoding change.

In an embodiment of the present disclosure, the transceiver module 1002 is further configured to: receive offset data sent by the first network side device, and the offset data is an offset value between a time when reception of control information is completed by the second network side device and a time when reception of the control information is completed by the terminal device.

In an embodiment of the present disclosure, the capability value includes a first value, and the first value is a first time required by the second network side device to complete a decoding of the control information.

In an embodiment of the present disclosure, the communication apparatus further includes a processing module 1002 configured to: determine a time m when reception of the control information is completed by the terminal device, wherein the control information at least includes new precoding information for the second network side device; and within a third time period, generate a reception or transmission beam using previously-obtained precoding matrix indication information or beam indication information, wherein the third time period is a time period from a third time to a fourth time, the third time is a sum of the time m and the offset value, and the fourth time is a sum of the third time and a time N1.

In an embodiment of the present disclosure, the processing module 1002 is further configured to: after the fourth time and before receiving new control information, enable a precoding matrix or beam indicated by the control information completely received at the time m to generate the reception or transmission beam.

In an embodiment of the present disclosure, the capability value includes a first value and a second value, the first value is a time N1 required by the second network side device to complete a decoding of the control information, and the second value is a hardware switching time N2 of the second network side device.

In an embodiment of the present disclosure, the processing module 1002 is further configured to: determine a time m when the reception of the control information is completed by the terminal device, wherein the control information at least includes new precoding information for the second network side device; and within a third time period, generate a reception or transmission beam using previously-obtained precoding matrix indication information or beam indication information, wherein the third time period is a time period from a third time to a fourth time, the third time is a sum of the time m and the offset value, and the fourth time is a sum of the third time and the time N1.

In an embodiment of the present disclosure, the processing module 1002 is further configured to: within a fourth time period, not constrain a precoding matrix or beam used by the terminal device, wherein the fourth time period is a time period from the fourth time to a fifth time, and the fifth time is a sum of the fourth time and the hardware switching time N2.

In an embodiment of the present disclosure, the processing module 1002 is further configured to: after the fifth time and before receiving new control information, enable a precoding matrix or beam indicated by the control information completely received at the time m to generate the reception or transmission beam.

In an embodiment of the present disclosure, the processing module 1002 is specifically configured to: in a case that there is an uplink and downlink channel reciprocity between the first network side device and the terminal device, generate the reception or transmission beam using precoding matrix indication information or beam indication information obtained at a previous moment; or in a case that there is an uplink data transmission for the terminal device and there is no uplink and downlink channel reciprocity between the first network side device and the terminal device, generate the reception or transmission beam using precoding matrix indication information or beam indication information used by a previous uplink channel; or in a case that there is a downlink data transmission for the first network side device and there is no uplink and downlink channel reciprocity, generate the reception or transmission beam using precoding matrix indication information or beam indication information used by a previous downlink channel.

With the communication apparatus in the embodiments of the present disclosure, the terminal device receives the capability value of the second network side device sent by the first network side device, and performs corresponding adjustment based on the capability value in a case that communication is performed via the relay or RIS, so as to improve the communication reliability.

FIG. 11 is a block diagram of another communication apparatus 110 according to an embodiment of the present disclosure. The communication apparatus 110 may be a network side device, a terminal device, or a chip, a chip system or a processor which supports the network side device to achieve the above-mentioned method, or a chip, a chip system or a processor which supports the terminal device to achieve the above-mentioned method. The communication apparatus 110 is used to achieve the above-mentioned methods, which will not be particularly defined herein.

The communication apparatus 1100 may include one or more processors 1101. The processor 1101 may be a general-purpose processor or special-purpose processor, e.g., a baseband processor or a central processing unit. The baseband processor is configured to process a communication protocol as well as communication data, and the central processing unit is configured to control the communication apparatus (e.g., a network side device, a baseband chip, a terminal device, a terminal device chip, a Distributed Unit (DU) or a Centralized Unit (CU)), execute a computer program, and process data in the computer program.

Alternatively or additionally, the communication apparatus 110 further includes one or more memories 1102 storing therein a computer program 1103. The computer program 1103 is executed by the processor 1101, so that the communication apparatus 110 implements the above-mentioned method. Alternatively or additionally, the memory 1102 further stores therein data. The communication apparatus 110 is arranged independent of, or integrated with, the memory 1102.

Alternatively or additionally, the communication apparatus 110 further includes a transceiver 1104 and an antenna 1105. The transceiver 1104 is also called as a transceiver unit, a transceiver machine or a transceiver circuit, and it is configured to achieve a transmission function and a reception function. The transceiver 1104 includes a receiver and a transmitter. The receiver is called as a receiving machine or a reception circuit, and it is configured to achieve the reception function. The transmitter is called as a transmitting machine or a transmission circuit, and it is configured to achieve the transmission function.

Alternatively or additionally, the communication apparatus 110 further includes one or more interface circuits 1106. The interface circuit 1106 is configured to receive a code instruction and transmit it to the processor 1101. The processor 1101 executes the code instruction, so that the communication apparatus 110 implements the above-mentioned method.

In a case that the communication apparatus is a first network side device, the transceiver 1104 is configured to execute Steps S201 and S202 in FIG. 2, and Steps S401, S402 and S403 in FIG. 4.

In a case that the communication apparatus 110 is a second network side device, the transceiver 1104 is configured to execute Step S501 in FIG. 5 and Step S601 in FIG. 6, and the processor 1101 is configured to execute Step S602 in FIG. 6 and Step S702 in FIG. 7.

In a case that the communication apparatus 110 is a terminal device, the transceiver 1105 is configured to execute Step S801 in FIG. 8, and Steps S901 and S902 in FIG. 9.

In an embodiment of the present disclosure, the processor 1101 may include a transceiver for achieving a reception function and a transmission function. For example, the transceiver is a transceiver circuit, an interface, or an interface circuit. The transceiver circuit, the interface or the interface circuit for achieving the reception function and the transmission function may be arranged separately, or integrated with each other. The transceiver circuit, the interface or the interface circuit is configured to read and write codes/data, or transmit/or transfer signals.

In an embodiment of the present disclosure, the processor 1101 stores therein a computer program, and the computer program is executed by the processor 1101, so that the communication apparatus 110 implements the above-mentioned method. The computer program may be programmed in the processor 1101, and in this case, the processor 1101 may be implemented through hardware.

In an embodiment of the present disclosure, the communication apparatus 110 includes a circuit for implementing the above-mentioned transmission, reception or communication function. The processor and the transceiver described in the embodiments of the present disclosure may be implemented in an Integrated Circuit (IC), an analog IC, a Radio Frequency IC (RFIC), a mixed-signal IC, an Application Specific Integrated Circuit (ASIC), a Printed Circuit Board (PCB) or an electronic device. The processor and the transceiver may also be manufactured through various IC processes, e.g., Complementary Metal Oxide Semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication apparatus mentioned hereinabove may be a network side device or a terminal device, but the scope of the communication apparatus is not limited thereto. In addition, a structure of the communication apparatus is limited to that in FIG. 11. The communication apparatus may be an independent device, or a part of a large device. For example, the communication apparatus may be: (1) an independent IC, chip, chip system or chip sub-system; (2) a set of one or more ICs (alternatively or additionally, the IC set also includes a memory member for storing therein data and a computer program; (3) an ASIC, e.g., a Modem; (4) a module capable of being embedded into the other device; (5) a receiver, a terminal device, a smart terminal device, a cellular phone, a wireless device, a handheld device, a mobile unit, a vehicle-mounted device, a network device, a cloud device, an artificial intelligence device, etc.; or (6) the other device.

In a case that the communication apparatus is a chip or a chip system, FIG. 12 is a block diagram of the chip according to an embodiment of the present disclosure. As shown in FIG. 12, the chip includes a processor 1201 and an interface 1202. There may exist one or more processors 1201, and more than one interface 1202.

In a case that the chip is used to achieve the function of the first network side device in the embodiments of the present disclosure, the interface 1202 is configured to: obtain a capability value of a second network side device, wherein the capability value is a time required by the second network side device to complete precoding or beam switching in a case of a precoding change or beam information change; and send precoding information to the second network side device.

In an embodiment of the present disclosure, the interface 1202 is specifically configured to: receive the capability value of the second network side device sent by the second network side device; or obtain the capability value to be met by the second network side device based on an agreement in a protocol.

In an embodiment of the present disclosure, the capability value includes a first value and/or a second value, the first value is a time required by the second network side device to complete a decoding of control information, and the second value is a hardware switching time of the second network side device.

In an embodiment of the present disclosure, the interface 1202 is specifically configured to: send uplink precoding information for the second network side device to the second network side device.

In an embodiment of the present disclosure, the second network side device is a RIS, and the uplink precoding information is used to indicate a precoding matrix used in a case that an uplink reflection or transmission is performed by the RIS; or the second network side device is a relay device, and the uplink precoding information is used to indicate a PMI or beam information used in a case that an uplink forwarding is performed by the relay device.

In an embodiment of the present disclosure, the interface 1202 is specifically configured to: send downlink precoding information for the second network side device to the second network side device.

In an embodiment of the present disclosure, the second network side device is a RIS, and the downlink precoding information is used to indicate a precoding matrix used in a case that a downlink reflection or transmission is performed by the RIS; or the second network side device is a relay device, and the downlink precoding information is used to indicate a PMI or beam information used in a case that a forwarding is performed by the relay device.

In an embodiment of the present disclosure, the interface 1202 is further configured to: send the capability value of the second network side device to a terminal device.

In an embodiment of the present disclosure, the interface 1202 is further configured to: send offset data to the terminal device, and the offset data is an offset value between a time when reception of the control information is completed by the second network side device and a time when reception of the control information is completed by the terminal device.

In a case that the chip is used to achieve the function of the second network side device in the embodiments of the present disclosure, the interface 1202 is configured to receive precoding information sent by a first network side device.

In an embodiment of the present disclosure, the interface 1202 is specifically configured to: receive uplink precoding information for the second network side device sent by the first network side device.

In an embodiment of the present disclosure, the second network side device is a RIS, and the uplink precoding information is used to indicate a precoding matrix used in a case that an uplink reflection or transmission is performed by the RIS; or the second network side device is a relay device, and the uplink precoding information is used to indicate a PMI or beam information used in a case that an uplink forwarding is performed by the relay device.

In an embodiment of the present disclosure, the interface 1202 is specifically configured to: receive downlink precoding information for the second network side device sent by the first network side device.

In an embodiment of the present disclosure, the second network side device is a RIS, and the downlink precoding information is used to indicate a precoding matrix used in a case that a downlink reflection or transmission is performed by the RIS; or the second network side device is a relay device, and the downlink precoding information is used to indicate a PMI or beam information used in a case that a forwarding is performed by the relay device.

In an embodiment of the present disclosure, the communication apparatus further includes a processor 1201 configured to determine a capability value of the second network side device, and the capability value is a time required by the second network side device to complete precoding switching in a case of a precoding change.

In an embodiment of the present disclosure, the interface 1202 is further configured to: send the capability value of the second network side device to the first network side device.

In an embodiment of the present disclosure, the capability value includes a first value, and the first value is a time N1 required by the second network side device to complete a decoding of control information.

In an embodiment of the present disclosure, the processor 1201 is further configured to: determine a time n when reception of the control information is completed by the second network side device, wherein the control information at least includes new precoding information for the second network side device; and within a first time period, perform signal processing using a previously-obtained precoding matrix or beam, wherein the first time period is a time period from the time n to a first time, and the first time is a sum of the time n and the time N1.

In an embodiment of the present disclosure, the processor 1201 is further configured to: after the first time and before receiving new control information, enable a precoding matrix or beam indicated by the control information completely received at the time n.

In an embodiment of the present disclosure, the capability value includes a first value and a second value, the first value is a time N1 required by the second network side device to complete a decoding of control information, and the second value is a hardware switching time N2 of the second network side device.

In an embodiment of the present disclosure, the processor 1201 is further configured to: determine a time n when reception of the control information is completed by the second network side device, wherein the control information at least includes new precoding information for the second network side device; and within a first time period, perform signal processing using a previously-obtained precoding matrix or beam, wherein the first time period is a time period from the time n to a first time, and the first time is a sum of the time n and the time N1.

In an embodiment of the present disclosure, the processor 1201 is further configured to: within a second time period, not constrain the precoding matrix or beam used by the second network side device, wherein the second time period is a time period from the first time to a second time, and the second time is a sum of the first time and the hardware switching time N2.

In an embodiment of the present disclosure, the processor 1201 is further configured to: after the second time and before receiving new control information, enable a precoding matrix or beam indicated by the control information completely received at the time n.

In an embodiment of the present disclosure, the processor 1201 is specifically configured to: in a case that there is an uplink and downlink channel reciprocity between the first network side device and a terminal device, perform the signal processing using a precoding matrix or beam obtained at a previous moment; or in a case that there is an uplink data transmission for the terminal device and there is no uplink and downlink channel reciprocity between the first network side device and the terminal device, perform the signal processing using a precoding matrix or beam used by a previous uplink channel; or in a case that there is a downlink data transmission for the first network side device and there is no uplink and downlink channel reciprocity, perform the signal processing using a precoding matrix or beam used by a previous downlink channel.

In a case that the chip is used to achieve the function of the terminal device in the embodiments of the present disclosure, the interface 1202 is configured to receive a capability value of a second network side device sent by a first network side device, and the capability value is a time required by the second network side device to complete precoding switching in a case of a precoding change.

In an embodiment of the present disclosure, the interface 1202 is further configured to: receive offset data sent by the first network side device, and the offset data is an offset value between a time when reception of control information is completed by the second network side device and a time when reception of the control information is completed by the terminal device.

In an embodiment of the present disclosure, the capability value includes a first value, and the first value is a first time required by the second network side device to complete a decoding of the control information.

In an embodiment of the present disclosure, the communication apparatus further includes a processor 1201 configured to: determine a time m when reception of the control information is completed by the terminal device, wherein the control information at least includes new precoding information for the second network side device; and within a third time period, generate a reception or transmission beam using previously-obtained precoding matrix indication information or beam indication information, wherein the third time period is a time period from a third time to a fourth time, the third time is a sum of the time m and the offset value, and the fourth time is a sum of the third time and a time N1.

In an embodiment of the present disclosure, the processor 1201 is further configured to: after the fourth time and before receiving new control information, enable a precoding matrix or beam indicated by the control information completely received at the time m to generate the reception or transmission beam.

In an embodiment of the present disclosure, the capability value includes a first value and a second value, the first value is a time N1 required by the second network side device to complete a decoding of the control information, and the second value is a hardware switching time N2 of the second network side device.

In an embodiment of the present disclosure, the processor 1201 is further configured to: determine a time m when the reception of the control information is completed by the terminal device, wherein the control information at least includes new precoding information for the second network side device; and within a third time period, generate a reception or transmission beam using previously-obtained precoding matrix indication information or beam indication information, wherein the third time period is a time period from a third time to a fourth time, the third time is a sum of the time m and the offset value, and the fourth time is a sum of the third time and the time N1.

In an embodiment of the present disclosure, the processor 1201 is further configured to: within a fourth time period, not constrain a precoding matrix or beam used by the terminal device, wherein the fourth time period is a time period from the fourth time to a fifth time, and the fifth time is a sum of the fourth time and the hardware switching time N2.

In an embodiment of the present disclosure, the processor 1201 is further configured to: after the fifth time and before receiving new control information, enable a precoding matrix or beam indicated by the control information completely received at the time m to generate the reception or transmission beam.

In an embodiment of the present disclosure, the processor 1201 is specifically configured to: in a case that there is an uplink and downlink channel reciprocity between the first network side device and the terminal device, generate the reception or transmission beam using precoding matrix indication information or beam indication information obtained at a previous moment; or in a case that there is an uplink data transmission for the terminal device and there is no uplink and downlink channel reciprocity between the first network side device and the terminal device, generate the reception or transmission beam using precoding matrix indication information or beam indication information used by a previous uplink channel; or in a case that there is a downlink data transmission for the first network side device and there is no uplink and downlink channel reciprocity, generate the reception or transmission beam using precoding matrix indication information or beam indication information used by a previous downlink channel.

Alternatively or additionally, the chip further includes a memory 1203 for storing therein necessary computer programs and data.

It should be appreciated that, various illustrative logical blocks and steps listed in the embodiments of the present disclosure may be implemented through electronic hardware, computer software, or a combination thereof. Whether these functions are implemented through hardware or software depends on design requirements on an entire system and specific applications. For each specific application, various methods are used to achieve the function, which however shall not be construed as going beyond the scope of the present disclosure.

The present disclosure further provides in some embodiments a communication system, which includes the communication apparatus as a terminal device and the communication apparatus as a network side device in FIG. 10, or includes the communication apparatus as a terminal device and the communication apparatus as a network side device in FIG. 11.

The present disclosure further provides in some embodiments a readable storage medium storing therein a readable storage medium storing therein an instruction. The instruction is executed by a computer to achieve the functions in any of the above method embodiments.

The present disclosure further provides in some embodiments a computer program product. The computer program product is executed by a computer to achieve the functions in any of the above method embodiments.

In the above-mentioned embodiments of the present disclosure, all of, or a part of, the modules are implemented in the form of software, hardware, firmware or a combination thereof. When the modules are implemented in the form of software, all of, or a part of, the modules are implemented in the form of a computer program product. The computer program product includes one or more computer programs. When the computer programs are loaded onto and executed by a computer, all of, or a part of, the processes or functions in the embodiments of the present disclosure are generated by the computer. The computer may be a general-purpose computer, a special-purpose computer, a computer network, or any other programmable device. The computer program may be stored in a computer-readable storage medium, or transferred from one computer-readable storage medium to another computer-readable storage medium, e.g., transferred from one website, one computer, one server or one data center to another website, another computer, another server or another data center in a wired manner (e.g., through a co-axial cable, an optical fiber, or a digital subscriber line (DSL)) or a wireless manner (e.g., infrared, cordless or microwave). The computer-readable storage medium may be any available medium capable of being accessed by a computer, or a data storage device, e.g., a server or a data center including one or more available mediums. The available medium may be a magnetic medium (e.g., a floppy disc, a hard disc or magnetic tape), an optical medium (e.g., a digital video disc (DVD)), or a semiconductor medium (e.g., a solid state disk (SSD)).

It should be appreciated that, such words as “first” and “second” are used to differentiate the items from each other, but shall not be construed as limiting the scope of the present disclosure or indicating any sequence.

The expression “at least one” is used to indicate one or more, e.g., two, three, four or more, which will not be particularly defined herein. In the embodiments of the present disclosure, for technical features of a same kind, the words “first”, “second”, “third”, “A”, “B”, “C” and “D” are used to differentiate these technical features, without indicating any sequence or sizes thereof.

The correspondence shown in each table in the present disclosure may be configured or predefined. Values of information in each table are for illustrative purposes only, and any other values may also be configured, which will not be particularly defined herein. In a case of configuring the correspondence between the information and parameters, it is not necessary to configure all the correspondences in the table. For example, in the table in the embodiments of the present disclosure, correspondences shown in some rows may not be configured. For another example, appropriate deformation or adjustment may be performed based on the table, e.g., splitting or combination. A name of each parameter in each table may use the other name capable of being understood by the communication apparatus, and a value of the parameter or a presentation mode thereof may also use that capable of being understood by the communication apparatus. During the implementation of each table, the other data structure may also be used, e.g., array, queue, container, stack, linear table, pointer, linked list, tree, map, structure, class, heap, or hash table.

The term “predefined” in the embodiments of the present disclosure may be understood as “defined”, “defined in advance”, “stored”, “pre-stored”, “pre-negotiated”, “preconfigured”, “programmed” or “pre-programed”.

It should be appreciated that, units and algorithm steps for instances described in the embodiments of the present disclosure may be implemented in the form of electronic hardware, or a combination of a computer program and the electronic hardware. Whether or not these functions are executed by hardware or software depends on specific applications or design constraints of the technical solution. Different methods may be adopted with respect to the specific applications so as to achieve the described functions, without departing from the scope of the present disclosure.

It should be further appreciated that, for convenience and clarification, operation procedures of the system, apparatus and units described hereinabove may refer to the corresponding procedures in the method embodiments, and thus will not be particularly defined herein.

The above embodiments are merely for illustrative purposes, but shall not be construed as limiting the scope of the present disclosure. Any person skilled in the art may make modifications and substitutions without departing from the spirit of the present disclosure, and these modifications and substitutions shall also fall within the scope of the present disclosure. Hence, the scope of the present disclosure shall be subject to the scope defined by the appended claims.

1. A method for sending precoding information, executed by a first network side device, comprising:
obtaining a capability value of a second network side device, wherein the capability value is a time required by the second network side device to complete precoding or beam switching in a case of a precoding change or beam information change; and
sending the precoding information to the second network side device.

2. The method according to claim 1, wherein the obtaining the capability value of the second network side device comprises:
receiving the capability value of the second network side device sent by the second network side device; or obtaining the capability value to be met by the second network side device based on an agreement in a protocol.

3. The method according to claim 1, wherein the capability value comprises at least one of a first value or a second value, the first value is a time required by the second network side device to complete a decoding of control information, and the second value is a hardware switching time of the second network side device.

4. The method according to claim 1, wherein the sending the precoding information to the second network side device comprises one of:
sending uplink precoding information for the second network side device to the second network side device; or
sending downlink precoding information for the second network side device to the second network side device.

5. The method according to claim 4, wherein the second network side device is a Reconfigurable Intelligence Surface (RIS), and the uplink precoding information indicates a precoding matrix used in a case that an uplink reflection or transmission is performed by the RIS; or
the second network side device is a relay device, and the uplink precoding information indicates a Precoding Matrix Indicator (PMI) or beam information used in a case that an uplink forwarding is performed by the relay device.

6. (canceled)

7. The method according to claim 4, wherein the second network side device is a RIS, and the downlink precoding information indicates a precoding matrix used in a case that a downlink reflection or transmission is performed by the RIS; or
the second network side device is a relay device, and the downlink precoding information indicates a PMI or beam information used in a case that a forwarding is performed by the relay device.

8. (canceled)

9. (canceled)

10. A method for receiving precoding information, executed by a second network side device, comprising:
receiving the precoding information sent by a first network side device.

11. The method according to claim 10, wherein the receiving the precoding information sent by the first network side device comprises one of:
receiving uplink precoding information for the second network side device sent by the first network side device; or
receiving downlink precoding information for the second network side device sent by the first network side device.

12. The method according to claim 11, wherein:
the second network side device is a Reconfigurable Intelligence Surface (RIS), and the uplink precoding information indicates a precoding matrix used in a case that an uplink reflection or transmission is performed by the RIS;
the second network side device is a relay device, and the uplink precoding information indicates a Precoding Matrix Indicator (PMI) or beam information used in a case that an uplink forwarding is performed by the relay device;
the second network side device is a RIS, and the downlink precoding information indicates a precoding matrix used in a case that a downlink reflection or transmission is performed by the RIS; or
the second network side device is a relay device, and the downlink precoding information indicates a PMI or beam information used in a case that a forwarding is performed by the relay device.

13. (canceled)

14. (canceled)

15. The method according to claim 10, further comprising:
determining a capability value of the second network side device, wherein the capability value is a time required by the second network side device to complete precoding switching in a case of a precoding change; and
sending the capability value of the second network side device to the first network side device.

16. (canceled)

17. The method according to claim 15, wherein the capability value comprises a first value, and the first value is a time N1 required by the second network side device to complete a decoding of control information.

18. The method according to claim 17, further comprising:
determining a time n when reception of the control information is completed by the second network side device, wherein the control information at least comprises new precoding information for the second network side device;
within a first time period, performing signal processing using a previously-obtained precoding matrix or beam, wherein the first time period is a time period from the time n to a first time, and the first time is a sum of the time n and the time N1; and
after the first time and before receiving new control information, enabling a precoding matrix or beam indicated by the control information completely received at the time n.

19. (canceled)

20. The method according to claim 15, wherein the capability value comprises a first value and a second value, the first value is a time N1 required by the second network side device to complete a decoding of control information, and the second value is a hardware switching time N2 of the second network side device.

21. The method according to claim 20, further comprising:
determining a time n when reception of the control information is completed by the second network side device, wherein the control information at least comprises new precoding information for the second network side device;
within a first time period, performing signal processing using a previously-obtained precoding matrix or beam, wherein the first time period is a time period from the time n to a first time, and the first time is a sum of the time n and the time N1;
within a second time period, not constraining the precoding matrix or beam used by the second network side device, wherein the second time period is a time period from the first time to a second time, and the second time is a sum of the first time and the hardware switching time N2; and
after the second time and before receiving new control information, enabling a precoding matrix or beam indicated by the control information completely received at the time n.

22-24. (canceled)

25. A method for receiving information, executed by a terminal device, comprising:
receiving a capability value of a second network side device sent by a first network side device, wherein the capability value is a time required by the second network side device to complete precoding switching in a case of a precoding change.

26. The method according to claim 25, further comprising:
receiving offset data sent by the first network side device, wherein the offset data is an offset value between a time when reception of control information is completed by the second network side device and a time when reception of the control information is completed by the terminal device.

27. The method according to claim 26, wherein the capability value comprises a first value, and the first value is a first time required by the second
network side device to complete a decoding of the control information; or the capability value comprises a first value and a second value, the first value is a time N1 required by the second network side device to complete a decoding of the control information, and the second value is a hardware switching time N2 of the second network side device.

28-37. (canceled)

38. A communication apparatus, comprising:
a processor; and
a memory, storing a computer program executable by the processor,
wherein the processor is configured to perform the method according to claim 1.

39. (canceled)

40. A communication apparatus, comprising:
a processor; and
a memory storing a computer program executable by the processor,
wherein the processor is configured to perform the method according to claim 10.

41. A communication apparatus, comprising:
a processor; and
a memory storing a computer program executable by the processor,
wherein the processor is configured to perform the method according to claim 25.
